(19) United States
(12) Patent Application Publication
(10) Pub. No.: US 2012/0116804 A1
(43) Pub. Date: May 10, 2012

(54) VISUALIZATION OF SOCIAL MEDICAL DATA

(75) Inventors: Yossi Mesika, Afula (IL); Haggai Roitman, Qiryat-Ata (IL); Yevgenia Tsimerman, Haifa (IL)

(73) Assignee: International Business Machines Corporation, Armonk, NY (US)

(21) Appl. No.: 12/939,176

(22) Filed: Nov. 4, 2010

(51) Int. Cl. G06Q 99/00

(52) U.S. Cl. 705/3

(57) ABSTRACT

A method, system, and computer program product for visualization of social medical data for a patient. The method including: providing a display representing part or all of a human body of a current patient; determining similar patients related by a bond of one or more entities to the current patient; determining an area of the body a binding entity relates to; and displaying an object representing a similar patient at the area of the body the binding entity relates to on the display representing the human body. Displaying an object representing a similar patient may reflect the level of similarity of the similar patient to the current patient according to the contribution to the similarity of the binding entity.

### BACKGROUND

This invention relates to the field of social medical data. In particular, the invention relates to visualization of social medical data.

Social-medical discovery is a new emerging discovery paradigm which combines social data with medical data.

One of the main applications of social-medical discovery is the patient collaboration applications (for example, www.patientslikeme.com (PatientsLikeMe is a trade mark of PatientsLikeMe) and www.curetogether.com (CureTogether is a trade mark of CureTogether, Inc.)) which given a patient as input, returns a list of patients, ranked by the level of similarity to that patient. Usually such similarity is calculated based on proximity of the patient health profile and the health profile of other patients. Social relationships between patients can be either explicit (for example, friendship relations) or can be implicitly derived based on social-medical similarity (for example, similarity based on medication consumption history). Social-medical relations include, in addition to traditional social relations between patients and physicians, various relationships between the patients/physicians and medical entities such as medications, allergies, immunizations, foods, treatment plans, etc., and including relationships between the medical entities themselves (for example, drug interactions).

Medical terms and knowledge are sometime too complicated for ordinary people, without proper medical background, to understand and explore. Yet, proper and intuitive use of available data can bring important insights to patients and to their physicians.

It remains a challenge to display social-medical data to a patient so the patient can easily understand his lineage to every similar patient. Given that many patients may exhibit similarity to a current patient based on different factors (for example, similarity based on medications or allergy types, etc.), each with a different level of similarity or different medical context (for example, diseases related to Orthopaedic or Cardiac aspects), the visualization solution should be able to summarize the “patients-like-me” data in a compact way in which patients can easily understand.

### BRIEF SUMMARY

According to a first aspect of the present invention there is provided a method for visualization of social medical data for a patient, comprising: providing a display representing part or all of a human body of a current patient; determining similar patients related by a bond of one or more entities to the current patient; determining an area of the body a binding entity relates to; displaying an object representing a similar patient at the area of the body the binding entity relates to on the display representing the human body; wherein said steps are implemented in either: computer hardware configured to perform said providing, determining and displaying steps, or computer software embodied in a non-transitory, tangible, computer-readable storage medium.

According to a second aspect of the present invention there is provided a computer program product for aggregation of social network data, the computer program product comprising: a computer readable storage medium having computer readable program code embodied therewith, the computer readable program code comprising: computer readable program code configured to: provide a display representing part or all of a human body of a current patient; determine similar patients related by a bond of one or more entities to the current patient; determine an area of the body a binding entity relates to; and display an object representing a similar patient at the area of the body the binding entity relates to on the display representing the human body.

According to a third aspect of the present invention there is provided a system for visualization of social medical data for a patient, comprising: a processor; a display component representing part or all of a human body of a current patient; a search component for determining similar patients related by a bond of one or more entities to the current patient; and a mapping component for determining an area of the body a binding entity relates to; and wherein the display component displays an object representing a similar patient at the area of the body the binding entity relates to on the display representing the human body.

### BRIEF DESCRIPTION OF THE SEVERAL VIEWS OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIGS. 1A, 1B, 1C and 1D are schematic diagrams illustrating a visualization of social medical data in accordance with the present invention;

FIG. 2 is a block diagram of a system in accordance with the present invention;

FIG. 3 is a block diagram of a computer system in which the present invention may be implemented; and

FIG. 4 is a flow diagram of a method in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

A method, system and computer program product are described in which social-medical data is visualized by representing patients who are medically similar to a given patient over a map of the human body. The human body is an intuitive representation outline for medical information and even patients with no medical background are familiar with it and can understand the visualization.

The location on the human body map of each similar patient is related to some medical entity that “binds” the current patient and similar patient together.

Visualized patients are further presented in different ways that annotate their similarity strength with current patient. For example, usage of different sized patient avatars may represent various levels of similarity to the current patient. Alternatively, different shades of a colour of patient icon may show the level of similarity to the current patient.

The visualization also allows a user to zoom in and out of the human body visualization, to focus on a specific area of interest and to view medical or social entities that bind the similar patients to the current patient.

The user can further refine the visualization by selecting entities of interest which in turn update the visualization to display only similar patients that are associated with those entities.

Other options in the visualization include the display of relationships between multiple similar patients and medical or social entities. The relationship between patients is either based on the binding medical entity (implicit relationship) or based on a (explicit) social network (e.g., family relationship).

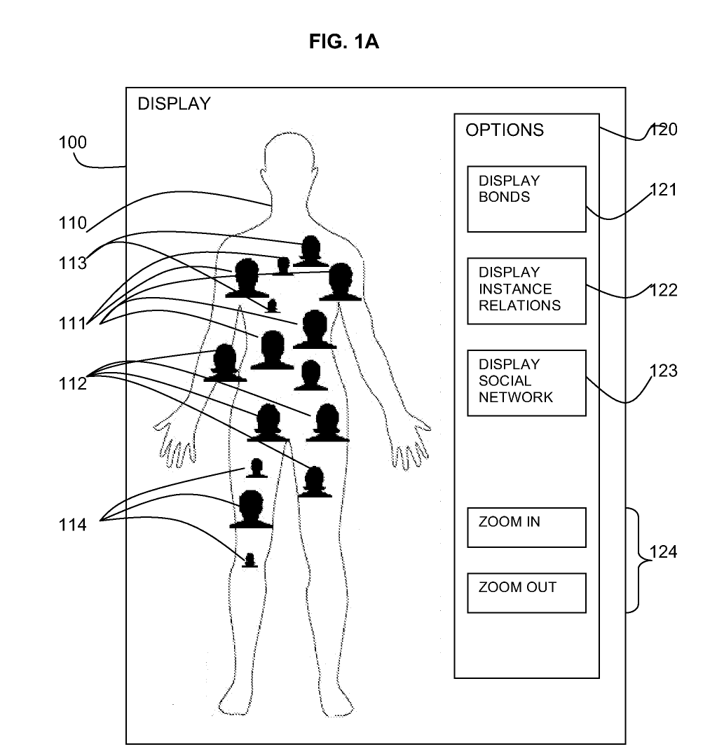

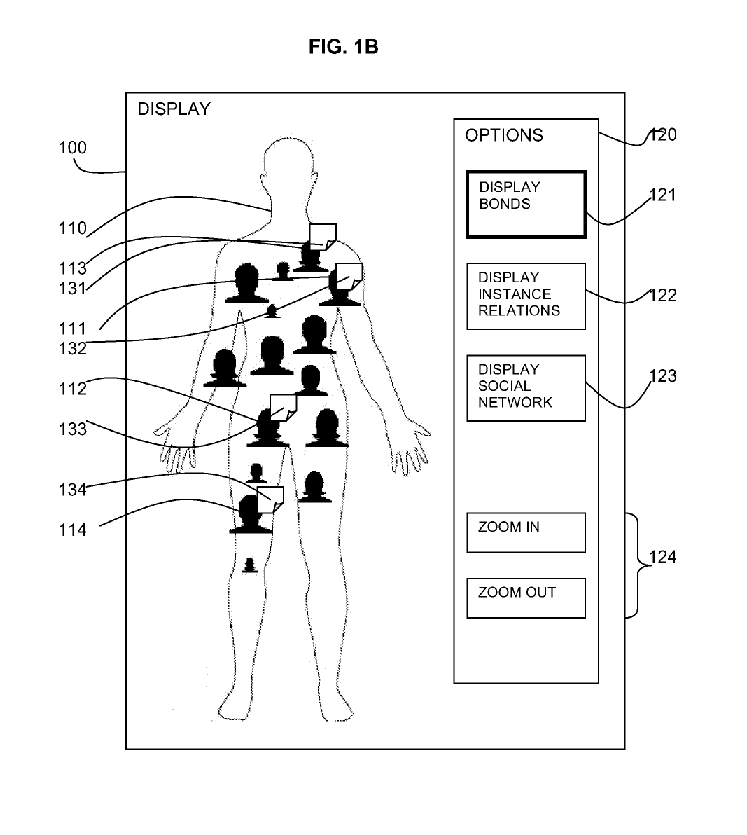

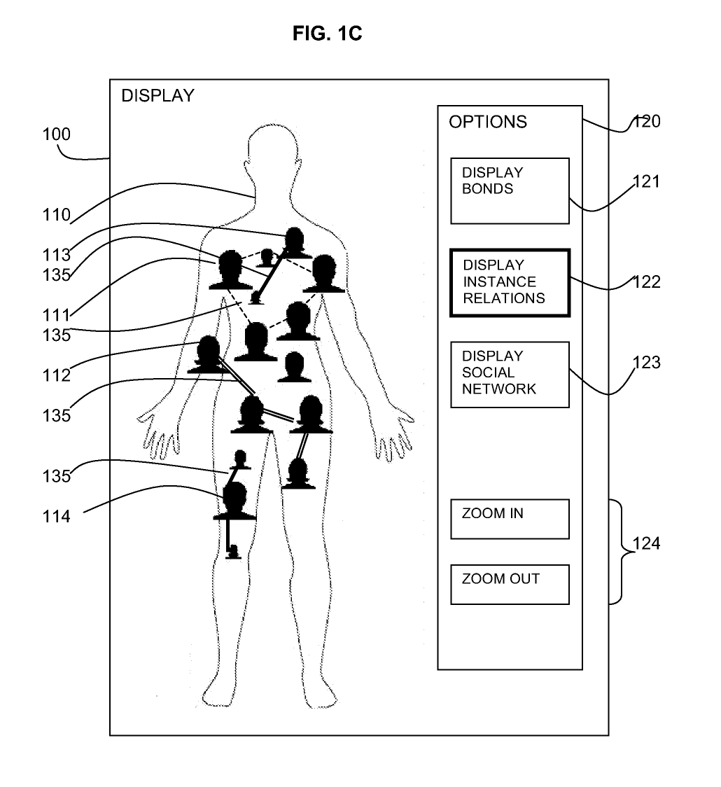

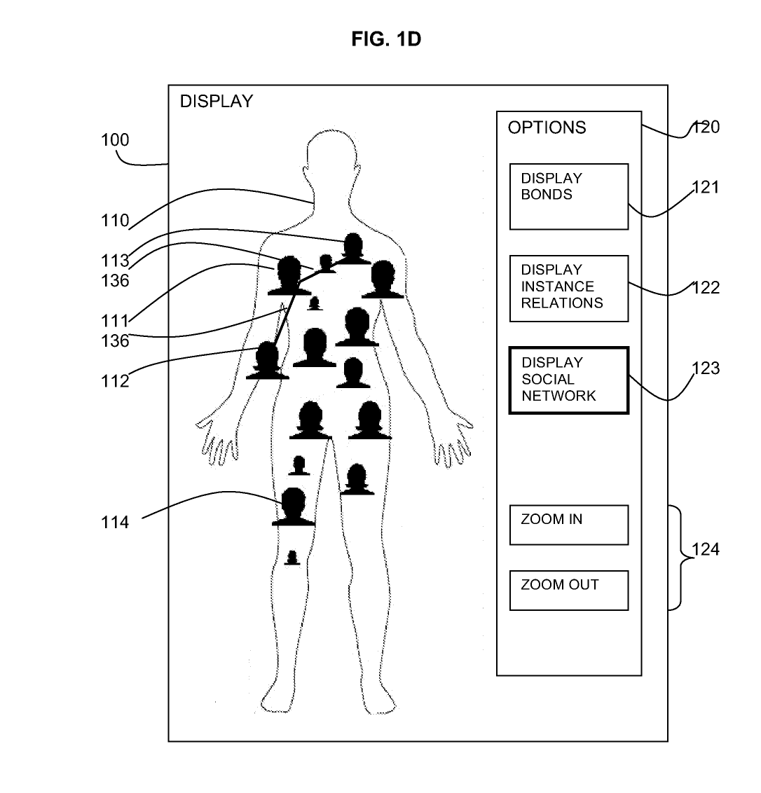

Referring to FIG. 1A, an example of a display 100 is shown in which the display 100 shows a representation of a human body 110. The representation of the human body 110 relates to a current patient and may be a male or female body in accordance with the gender of the current patient. The representation of a human body 110 may be a 2D or 3D representation.

The representation of a human body 110 shown in FIG. 1A is an outline representation; however further detail on the internal organs and skeleton may be shown. At locations on the representation of the human body 110, an object, avatar, or other form of representation of similar patients 111-114 to the current patient may be shown. Multiple instances of a similar patient avatar 111 may be displayed at different locations on the representation of the human body 110 according to the location on the human body related to each entity binding the similar patient to the current patient.

The display 100 may have display options 120 including, for example, an option to display bonds 121, an option to display instance relations 122, and option to display social network 123. An option may also be provided to zoom in or out 124 of an area of the representation of the human body 110.

Referring to FIG. 1B, the display 100 shows a representation of a human body 110 with the option of displaying bonds 121 selected. The display of bonds 121 may visualize in relation to each similar patient avatar 111-114, an icon 131-134 representing the entity type and, optionally, further information on the exact bond between the similar patient to the current patient.

Referring to FIG. 1C, the display 100 shows a representation of a human body 110 with the option of displaying instance relations 122 selected. The display of instance relations 122 may visualize all instances of a similar patient 111. For example, by showing connecting lines 135 between instances of a similar patient 111.

Referring to FIG. 1D, the display 100 shows a representation of a human body 110 with the option of displaying a social network selected 123. The display of a social network 123 may visualize all socially related similar patients 111, 112, 113. For example, by showing connecting lines 136 between related similar patients 111, 112, 113.

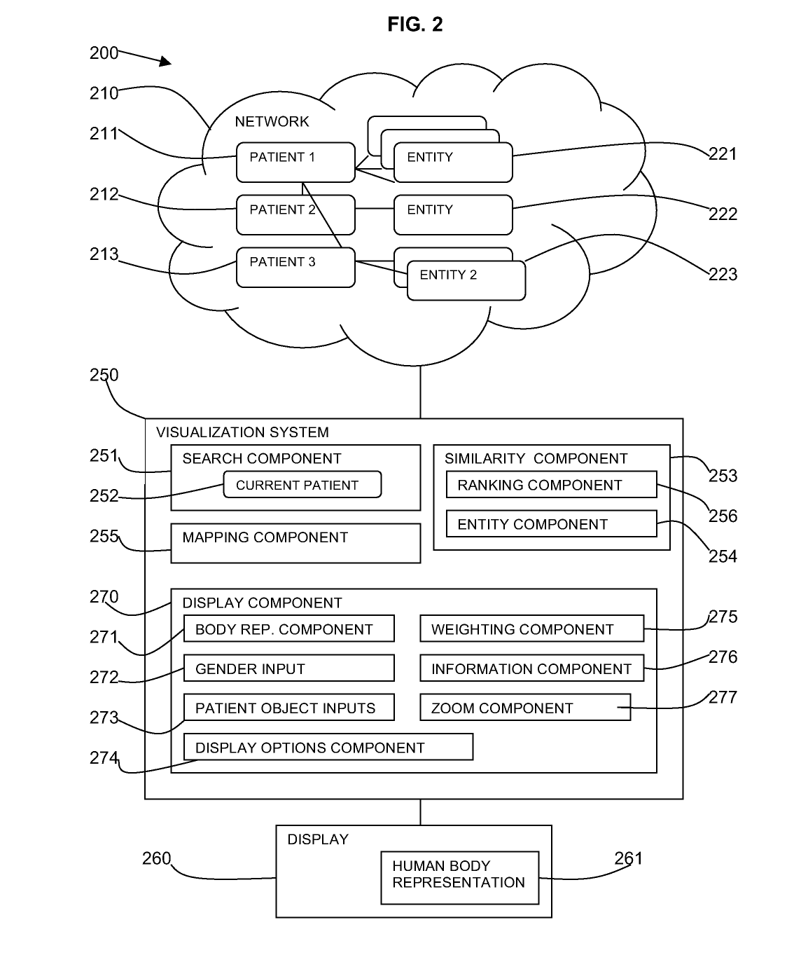

Referring to FIG. 2, a block diagram shows an embodiment of a described system 200. A network or database 210 of patients may be accessed (referred to herein as a network 210). The network 210 may include multiple patients 211-213 with stored connections to entities 221-223. Entities 221-223 may be medical entities which bind a patient 211-213 to another patient 211-213 and which related to a part of the body.

For example, an entity 221-223 may be a medical entity such as a drug or medicine, an illness or disease, a symptom, another person such as a physician, a record such as an x-ray or other result showing a particular symptom, a DNA sequence, a blood group, etc.

Patients 211-213 may also be related by a social network, such as a family relationship, a shared experience (for example, time in the armed forces, or in a work environment), etc.

A visualization system 250 may include a search component 251 for searching the network 210 for patients 211-213 similar or related to a current patient 252 input into the search component 251. The visualization system 250 may also include a similarity component 253 for calculating a similarity function to provide a measure of similarity between the current patient 252 and similar patients 211-213. The similarity component 253 may include a ranking component 256 for ranking similar patients 211-213. The similarity component 253 may also include an entity component 254 for analysing the entities 221-223 that explain the similarity of a similar patient 211-213, including determining the relative contribution of each entity 221-223.

The visualization system 250 may also include a mapping component 255 for mapping a representation of a similar patient 211-213 to a relevant area of a human body representation 261 representing the current patient 252 provided on a display 260. The mapping component 255 may determine which part of the body an entity 221-223 binding the similar patient 211-213 to the current patient 252 relates to. The mapping component 255 may determine how the representation of the similar patient 211-213 is displayed at each location on the human body representation 261, for example depending on the strength of the relationship for that binding entity 221-223.

A display component 270 may provide a human body representation component 271 for providing a human body representation of the current patient 252. The display component 270 may include a gender input 272 for determining whether the human body representation is a male or female representation. The display component 270 may also include patient object inputs 273 for the similar patient representations (patient avatars), and a display options component 274 for displaying different selected options such as bonds, patient instances, etc. A weighting component 275 may be provided for displaying similar patient representations reflecting the strength of relationship (for example, patient avatar size, color, etc.). An information component 276 may determine the information to be displayed when a user hovers over a similar patient representation. The display component 270 may also include a zoom component 277 for enabling a user to zoom in or out of the display 260. The display component 270 may also include display options 277.

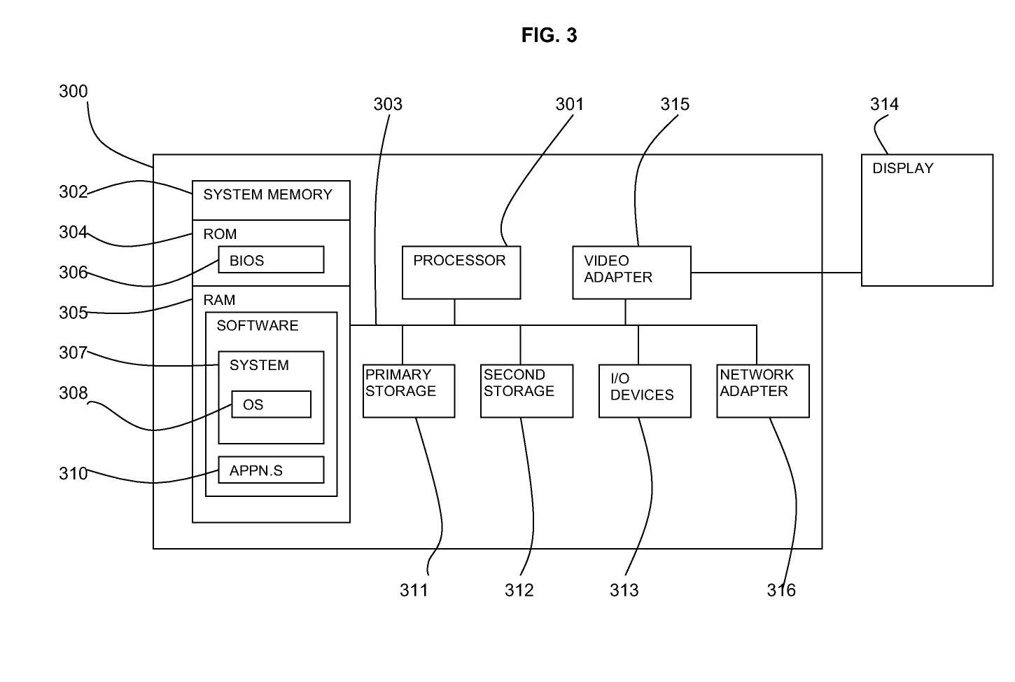

Referring to FIG. 3, an exemplary system for implementing aspects of the invention includes a data processing system 300 suitable for storing and/or executing program code including at least one processor 301 coupled directly or indirectly to memory elements through a bus system 303. The memory elements can include local memory employed during actual execution of the program code, bulk storage, and cache memories which provide temporary storage of at least some program code in order to reduce the number of times code must be retrieved from bulk storage during execution.

The memory elements may include system memory 302 in the form of read only memory (ROM) 304 and random access memory (RAM) 305. A basic input/output system (BIOS) 306 may be stored in ROM 304. System software 307 may be stored in RAM 305 including operating system software 308. Software applications 310 may also be stored in RAM 305.

The system 300 may also include a primary storage means 311 such as a magnetic hard disk drive and secondary storage means 312 such as a magnetic disc drive and an optical disc drive. The drives and their associated computer-readable media provide non-volatile storage of computer-executable instructions, data structures, program modules and other data for the system 300. Software applications may be stored on the primary and secondary storage means 311, 312 as well as the system memory 302.

The computing system 300 may operate in a networked environment using logical connections to one or more remote computers via a network adapter 316.

Input/output devices 313 can be coupled to the system either directly or through intervening I/O controllers. A user may enter commands and information into the system 300 through input devices such as a keyboard, pointing device, or other input devices (for example, microphone, joy stick, game pad, satellite dish, scanner, or the like). Output devices may include speakers, printers, etc. A display device 314 is also connected to system bus 303 via an interface, such as video adapter 315.

A similarity function may be assumed S(p,p′) for two patients (p,p′) as input, namely a current patient p and a similar patient p′. The similarity function returns the similarity level between the two patients and a list of medical entities that mostly explain this similarity (i.e., bind the two patients). The list of entities may be denoted E(p,p′)={e1, e2, . . . , en}.

A current patient is visualized as a human body map. It is assumed that each similar or related patient is represented by some object for visualization, for example, a patient avatar. Each medical entity may be mapped to an (x,y,z) coordinate over the human body map depending on the part of the body to which the entity relates. Displayed human body map depends on the current patient gender, i.e., if the patient is a male, a male figure is displayed.

For example, the mapping of entities may be done using medical terminologies (e.g., SNOMED CT, ICD9) and relationships to the binding entities. Given a medical entity, its corresponding medical knowledge can be used to extract an approximation of its location in the human body. For example, a medication that treats cardiac diseases will be mapped to the heart area (since cardiac relates to the heart), etc. As another example, assuming that Warfarin medication is the entity, it can be mapped it to the liver location on the human body map as the Warfarin medication relates to treatment of the liver, etc.

Given a current patient p, similar patients p′ are ranked in the system using the similarity function S(p,p′). Let E(p,p′) be the set of medical entities that bind the two patients, ordered by their marginal contribution to this bond.

Every similar patient's p′ object (e.g., avatar) may be then placed on the human body map once or |E(p,p′)| times. Assuming that patient p′ is placed in some location (x, y, z) in the human body map due to entity e in E(p,p′), the similar patient's object (avatar) is displayed sized relative to the marginal contribution of entity e to the bond between patient p and p′. Therefore, the more contributing entity e is to the similarity between similar patient p′ and current patient p, the larger patient p′ object will be displayed.

The patient p′ object sizes are proportional to the marginal similarity contribution of the binding entity, which can be denoted S(p,p′|e). This number may be normalized so various patient p′ objects can be comparable. One way is to divide S(p,p′|e) by sum of all S(p,p′) over all similar patients p′.

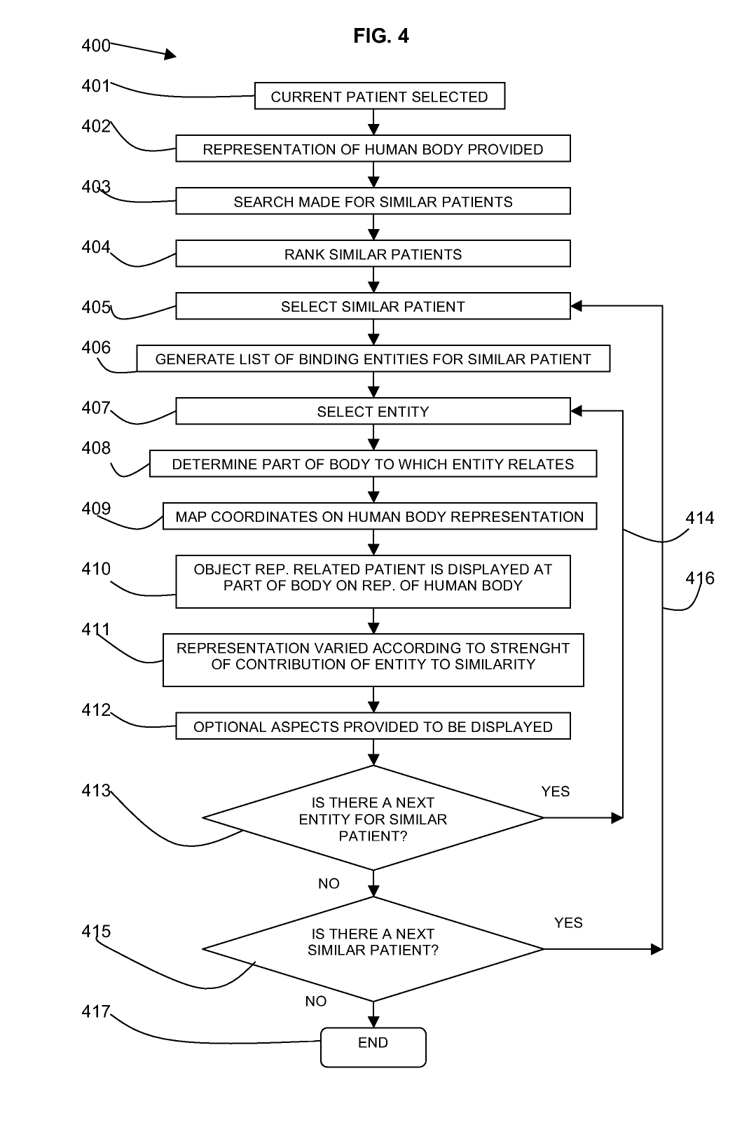

Referring to FIG. 4, a flow diagram 400 shows an embodiment of the described method. A current patient p is selected 401. A representation of a human body of the current patient p is provided 402. The representation may denote the gender of the current patient p, may be a suitable representation for an age of the current patient, and may include other known details of the current patient, such as disabilities, etc.

A search may be made 403 for determining similar or related patients based on binding entities. Similar patients p′ may be ranked 404 using a similarity function S(p,p′).

A first similar patient p′ may be selected 405. A list of entities E(p,p′) that contribute to the similarity of the first similar patient p′ to the current patient p may be generated 406.

A first entity is selected 407 and the part of the body to which the first entity relates may be determined 408. The entity may be mapped 409 to the coordinates on a provided human body map. An avatar of the similar patient p′ may be displayed 410 at the coordinates for the entity. The representation of the avatar may be varied 411 (for example, size, color, etc.) to reflect to the strength of the contribution of the entity to the similar patient's p′ similarity to the current patient p. This may be normalised so various similar patients can be comparable. Optional additional aspects may be provided 412 to be displayed on selection by a user.

The process repeats for the next entity for the first similar patient p′. It is determined 413 if there is a next entity for the patient p′. If so the process loops 414 and steps 407 to 412 are repeated. If there are no further entities for the similar patient p′, it is then determined 415 if there is a next similar patient p′ related to the current patient. If so the process loops 416 and steps 405 to 414 are repeated for entities of the next similar patient. If there are no further similar patients, the process ends 417.

The visualization may further provide the following example options.

Bond display: when this button is pressed, the visualization displays next to each patient's object (avatar) also an icon representing the entity type and some title (label) which provides information on the exact bond. For each icon we can also display a number or a color scale representing the level of similarity.

Connection to other patient instances located on the human body map: in case we display the patient object (avatar) several times, this button connects all patient instances to provide the current patient a clear overview on all binding (similarity) factors with displayed patient.

Display of patient explicit or implicit social network: pressing on this button, shows the social network between different similar patients to current patient. Different patients may be connected based on social relationships known to exist among them. For example, two patient objects may be connected based on a known family relationship. The connection may also show a label of that relationship type. Other social relationship types may be based on location, occupation, interests, etc.

Zoom in/out: zooming in or out can be used to focus the patient attention to a certain and more specific part in the human body map.

Facet filtering and navigation: by clicking on a certain entity type, the patient can further refine the display by focusing it only on similar patients that include binding entities of the same or approximate type, similar to faceted search and navigation.

Hovering information: in case the patient hovers with the mouse pointer over some patient object, a detailed explanation about the specific bond is display to the user, e.g., details about the medication that bond the two patients together, the exact similarity between the two patients with respect to that medication (e.g., the current patient takes 20 mg and the hovered patient 40 mg).

A social medical visualization system may be provided as a service to a customer over a network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for visualization of social medical data for a patient, comprising:
providing a display representing part or all of a human body of a current patient;
determining similar patients related by a bond of one or more entities to the current patient;
determining an area of the body a binding entity relates to;
displaying an object representing a similar patient at the area of the body the binding entity relates to on the display representing the human body;
wherein said steps are implemented in either:
computer hardware configured to perform said providing, determining and displaying steps, or
computer software embodied in a non-transitory, tangible, computer-readable storage medium.

2. The method as claimed in claim 1, wherein displaying an object representing a similar patient reflects the level of similarity of the similar patient to the current patient according to the contribution to the similarity of the binding entity.

3. The method as claimed in claim 1, wherein displaying an object representing a similar patient reflects the level of similarity includes one or more of the group of: variation in size, color, shading, opacity.

4. The method as claimed in claim 1, wherein determining similar patients includes ranking the similar patients in order of similarity to the current patient according to a similarity function.

5. The method as claimed in claim 4, wherein the similarity function is based on one or more binding entities.

6. The method as claimed in claim 1, including:
selectively displaying in relation to the object representing a similar patient, an object representing the binding entity type.

7. The method as claimed in claim 1, including:
selectively displaying connections to other instances of the same similar patient displayed on the human body representation.

8. The method as claimed in claim 1, including:
selectively displaying a social network between multiple similar patients displayed on the human body representation.

9. The method as claimed in claim 1, including:
selectively zooming in or out of the human body representation to focus on a specific part of the current patient's human body representation.

10. The method as claimed in claim 1, including:
selecting an entity type and filtering to display similar patients with binding entities of the selected entity type.

11. The method as claimed in claim 1, including:
providing additional information on the display relating to a binding entity and a similar patient.

12. A computer program product for aggregation of social network data, the computer program product comprising:
a computer readable storage medium having computer readable program code embodied therewith, the computer readable program code comprising:
computer readable program code configured to:
provide a display representing part or all of a human body of a current patient;
determine similar patients related by a bond of one or more entities to the current patient;
determine an area of the body a binding entity relates to; and
display an object representing a similar patient at the area of the body the binding entity relates to on the display representing the human body.

13. A system for visualization of social medical data for a patient, comprising:
a processor;
a display component representing part or all of a human body of a current patient;
a search component for determining similar patients related by a bond of one or more entities to the current patient; and
a mapping component for determining an area of the body a binding entity relates to;
and wherein the display component displays an object representing a similar patient at the area of the body the binding entity relates to on the display representing the human body.

14. The system as claimed in claim 13, wherein the display component displaying an object representing a similar patient reflects the level of similarity of the similar patient to the current patient according to the contribution to the similarity of the binding entity.

15. The system as claimed in claim 13, wherein the display component displaying an object representing a similar patient reflects the level of similarity includes one or more of the group of: variation in size, color, shading, opacity.

16. The system as claimed in claim 13, wherein the search component for determining similar patients includes a ranking component for ranking the similar patients in order of similarity to the current patient according to a similarity function.

17. The system as claimed in claim 16, wherein the similarity function is based on one or more binding entities.

18. The system as claimed in claim 13, wherein the display component includes a display options component including an option to selectively display in relation to the object representing a similar patient, an object representing the binding entity type.

19. The system as claimed in claim 13, wherein the display component includes a display options component including an option to selectively display connections to other instances of the same similar patient displayed on the human body representation.

20. The system as claimed in claim 13, wherein the display component includes a display options component including an option to selectively display a social network between multiple similar patients displayed on the human body representation.

21. The system as claimed in claim 13, wherein the display component includes a zoom component to selectively zoom in or out of the human body representation to focus on a specific part of the current patient's human body representation.

22. The system as claimed in claim 13, wherein the display component includes a display options component including an option to select an entity type and filter to display similar patients with binding entities of the selected entity type.

23. The system as claimed in claim 13, wherein the display component includes an information component for providing additional information on the display relating to a binding entity and a similar patient.
